(19) United States
(12) Patent Application Publication
(10) Pub. No.: US 2004/0039672 A1
(43) Pub. Date: Feb. 26, 2004

(54) Trust model router

(76) Inventors: Predrag Zivic, Toronto (CA); Jovan Miladinovic, Toronto (CA); Slavoljub Pavlovic, Toronto (CA)

Correspondence Address: Mark B. Eisen, c/o Dimock Stratton Clarizio LLP, Suite 3202, Box 102, 20 Queen Street West, Toronto, M5H 3R3, CA

(21) Appl. No.: 10/173,443

(22) Filed: Jun. 18, 2002

(51) Int. Cl. G06F 17/60

(52) U.S. Cl. 705/36

(57) ABSTRACT

A system and method for bridging between trust models allows parties to an e-commerce transaction to use different trust models, while still effecting the transaction with all of the necessary safeguards and comforts which would be available by effecting the transaction within a single trust model. A trust model router implements security technology that provides an interface between existing trust models and provides for the usage of disparate technologies in an e-commerce transaction. The trust model router comprises a set of secure check rules, which determine to which trust model the information should be routed and what type of certification technology should be used. Based on information obtained by an issuing certificate authority, the trust model router of the invention determines the type of trust model to be used in the transaction and follows rules-based procedures consistent with the trust model to properly record and complete the transaction. The trust model router is trusted to perform transaction routing on a behalf of a trusted model, because it is certified by the participating trust model or transaction standards frameworks.

### FIELD OF INVENTION

This invention relates to Internet based transaction certification and validation. In particular, this invention relates to a system and method for validating any Internet transaction, including financial, insurance, government, health and like Internet based transactions undertaken within disparate financial standards frameworks.

### BACKGROUND OF THE INVENTION

The implementation of certification and Public Key Infrastructure (PKI) technologies has followed a dogmatic and specific implementation path. These approaches have ensured that organization internal business processes and information are well protected internally, but communication of information and business cooperation between organizations has been very difficult.

Different associations and new technologies have made it possible for information to be shared between organizations in a secure fashion. This has forced one standard to rise above all others within each association, where association members work in concert to develop defined standards, or “trust models,” and technology to fulfill the trust model, and all association members are forced to follow the “standardized” trust model. However, this has created the problem of how to reconcile different trust models enforced by different associations.

In order to facilitate Internet based transactions, such transaction standards frameworks have been developed to provide credible and trustworthy third party validation and authentication of the transacting parties and compliance with transaction parameters. For example, certificate-based authentication and validation services are available which are designed to facilitate trusted e-commerce financial transactions that meet the defined standards. Such certificate-based authentication is also used for confidential information exchange, for example relating to insurance, government, health, legal and other documents, or any information exchange requiring the usage of a certification authority in a specified trust model.

One such trust model which is commonly used in the United States is the Identrus standard. Identrus is a framework of standards that enables banks to serve as trusted third parties in e-commerce transactions. Such transactions may extend to contractual payments, trade financing, letters of credit, online markets, contracts of insurance, investment trading and government filings, amongst others.

In Canada the Canadian Payment Association (CPA) is used as the primary e-commerce transaction trust model. Also, individual organizations, including financial institutions and government organizations, introduce and develop their own strongly regulated certification and trust models to implement security technology which meets the security functions associated with e-commerce transactions. Each of these trust models has different specifications and requirements for certificate validation, storage, transaction completion flow and authentication processes. In these disparate standards frameworks, different technologies are used to provide for availability, data integrity, data confidentiality and accountability (non-repudiation) in connection with Internet based transactions, including c-commerce transactions and information exchange transactions involving a certifying authority.

These trust models are mutually incompatible, and as such all transacting parties must operate within a single trust model in order to effect an e-commerce and internet based transaction. This can lead to difficulties when it comes to choosing a trust model to govern a transaction, as the transacting parties, their respective financial advisors and/or their respective financing institutions may have different preferences or levels of comfort dealing with one or another particular trust model. Forcing a transacting party to concede to using a trust model (or not using a proper trust model) which does not provide the level of comfort that the party needs to effect the transaction can reduce the effectiveness of certification authorities as a facilitator of e-commerce and internet based activities. Also, the technologies developed and used around these different trust models are disparate and do not always completely follow the standards. This presents a considerable problem in the implementation of different tasks such as organization business cooperation, service providing and government and business transaction exchange.

It would accordingly be advantageous to provide a mechanism for bridging disparate trust models, whereby an e-commerce and other internet based transactions can take place with different transacting parties operating under disparate trust models.

### SUMMARY OF THE INVENTION

The present invention addresses the incompatibility of disparate trust models and provides a system and method for bridging or interfacing between trust models. This allows different parties to an any Internet based transaction to use different trust models, while still effecting the transaction with all of the necessary safeguards and comforts which would be available by effecting the transaction within a single trust model.

The invention accomplishes this by providing a secure trust model router, which implements security technology that provides an interface between existing trust models. Through usage of secure routing rules, the trust model router of the invention enables the integration of different trust models and provides for the usage of disparate technologies in an Internet based transaction.

The invention provides a system and method for securely routing information between different trust models and different electronic certification technologies. The trust model router of the invention comprises a set of secure check rules, which determine to which trust model the information should be routed and what type of certification technology should be used. The invention integrates certification technologies and provides an interface which enables different organizations and technologies to work seamlessly together and at the same time follow defined trust model processes.

According to the information obtained by an issuing certificate authority in respect of a first Client (for example, a buyer) and a second Client (for example, a seller) certificate and transaction type, the trust model router of the invention determines the type of trust model to be used in the transaction. The trust model router selects the appropriate type of trust model, and follows rules-based procedures consistent with the trust model to properly record the transaction.

For example, the trust model router of the invention follows a buyer's (Client 1) purchase request to a seller (Client 2). An Accompanying Transaction Buyer's (Client 1) Certificate information is used to determine the appropriate issuing certificate authority. The seller (Client 2) receives a transaction request, and sends a verification request to its certificate issuing authority for authentication and transaction verification. The trust model router of the invention uses the seller (Client 2) transaction verification request signed with its digital certificate to determine the seller (Client 2) issuing certificate authority, for determination of the appropriate trust model type. The trust model router determines trust model types and transaction request type from its rules table. The transaction is then routed to the proper trust model.

If the trust models for the seller (Client 2) and buyer (Client 1) are different, the trust model router of the invention will follow the rules for both trust models, in effect creating a hybrid trust model using model-defined certificate extensions assigned by the certificate authorities for each trust model. The trust model router of the invention thus enables the use of any specified trust models, routing between the disparate trust models and bridging or interfacing the two trust models by completing a transaction within the framework of one trust model on behalf of the other trust model. The trust model router of the invention will also enable smaller institutions that cannot afford membership in an international trust model, or the development of an application to use a specific trust model, to solve the challenge of effecting secure e-commerce and other internet based transactions.

The trust model router becomes a trusted routing body since it is certified by different trust models. To complete a transaction on a behalf of a trust model, the participating trust model certifies the trust model router. Therefore, the Internet based transaction routing is certified by a trusted transaction standards framework or trust model.

The present invention thus provides a system for conducting an Internet based transaction through a plurality of trust models each defining a series of rules for the conduct of an Internet based transaction, comprising a workflow database comprising workflow parameters associated with the plurality of trust models, a validation server for validating a certificate issued in accordance with a certificate authority and trust model, a rules engine for generating an extensions certificate or using an existing extensions certificate comprising selected information extracted from the certificate, and a transaction log database for recording information relating to the transaction. In further aspects of the system of the invention: a transaction log is certified and encrypted using certificates issued by a selected trust model transaction process; and/or the transaction log comprises information relating to validation, extensions, rules and models used in the transaction.

The present invention further provides a method of conducting an Internet based transaction, comprising the steps of: a. Obtaining information about an issuing certificate authority from a certificate issued to a first party according to a first trust model; b. Validating the certificate according to rules of the first trust model; c. Selecting from the certificate a transaction application that will use the certificate to complete the transaction; d. Determining the originating trust model of the request for a transaction; e. Selecting a trust model routing based on the issuing certificate authority and transaction application and a lookup of the trust model and requesting party from a routing rules engine; f. Stripping extension information from the certificate and reorganizing the extension information into a form compatible with at least one receiving trust model of at least one other party to the transaction; g. embedding the extension information in an extension certificate; h. Routing the requested transaction according to the selected trust model workflow description; i. Logging transaction information; and j. Completing the transaction with verification by the at least one receiving trust model.

In further aspects of the method of the invention: steps f., h. and j. are applied to a plurality of receiving trust models; the transaction information is recorded in a transaction log; the transaction log is certified and encrypted using certificates issued by the selected trust model transaction process; and/or the transaction log comprises information relating to validation, extensions, rules and models used in the transaction.

### BRIEF DESCRIPTION OF THE DRAWINGS

In drawings which illustrate by way of example only a preferred embodiment of the invention,

FIG. 1 is a schematic illustration of a trust model router according to the invention;

FIG. 2 is a schematic illustration of a trust model router according to a further embodiment of the invention;

FIG. 3 is a certificate according to a preferred embodiment of the invention;

FIG. 4 is a flow chart showing the method of the invention; and

FIG. 5 is a block diagram showing the components of the system of the invention

### DETAILED DESCRIPTION OF THE INVENTION

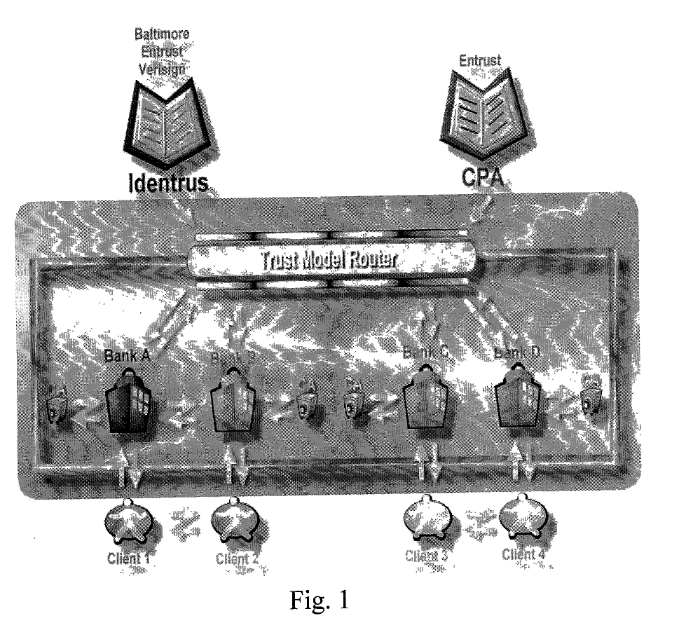

FIG. 1 illustrates a first preferred embodiment of the trust model router according to the invention, in which two financial trust models are enforced by two different international trust model bodies, Indentrus (Trust Model 1 or TM1) and CPA (Trust Model 1 or TM2). The trust model router TMR is provided as an interface between the two trust models TM1 and TM2, to enable both member institutions and non-member institutions to effect e-commerce transactions using the different trust models. The invention will be described in the environment of an e-commerce transaction, where Client 1 is a buyer and Client 2 is a seller, however it will be appreciated that the invention is applicable to any Internet based transactions involving a certification authority, including e-commerce transactions and information exchange transactions such as those relating to insurance, government, health, legal and other documents and information.

The trust model router TMR of the invention solves the issue of reconciling and interaction between different rules for any kind of business transaction. The different cases that are solved by the trust model router of the invention can be seen in the following tables, for the example of a buyer B (or Client 1 for non-financial transactions) and seller S (or Client 2 for non-financial transactions) in an e-commerce purchase transaction. Table 1 presents transactions applying the trust model router TMR where two trust models TM1 and TM2 are involved, and Table 2 presents transactions applying the trust model router TMR where three trust models TM1, TM2 and TM3 are involved, showing how the trust model router TMR addresses the various possible cases.

In Table 1 the assumption taken in consideration for trust model relations is that the buyer B (Client 1) and seller S (Client 2) are members of associations that enforce Trust Model 1 and/or Trust Model 2 and/or both trust models TM1, TM2.

TBALE 1

| | | | Seller |
|---|---|---|---|
| | Seller TM1 | Seller TM2 | TM1 & TM2 |
| Buyer TM1 | TM1 | Trust Model Router | Trust Model |
| | | | Router |
| Buyer TM2 | Trust Model Router | TM2 | Trust Model |
| | | | Router |
| Buyer TM1 | Trust Model Router | Trust Model Router | TM1 & TM2 = |
| & TM2 | | | TMR |

TABLE 2

| | S- | S- | S- | S | S | S | S TM1- |
|---|---|---|---|---|---|---|---|
| | TM1 | TM2 | TM3 | TM1-2 | TM1-3 | tm2-3 | 2-3 |
| B-TM1 | TM1 | TMR | TMR | TMR | TMR | TMR | TMR |
| B-TM2 | TMR | TM2 | TMR | TMR | TMR | TMR | TMR |
| B-TM3 | TMR | TMR | TM3 | TMR | TMR | TMR | TMR |
| B | TMR | TMR | TMR | TM1-2 = | TMR | TMR | TMR |
| TM1-2 | | | | TMR | | | |
| B | TMR | TMR | TMR | TMR | TM1-3 = | TMR | TMR |
| TM1-3 | | | | | TMR | | |
| B | TMR | TMR | TMR | TMR | TMR | TM2- | TMR |
| TM2-3 | | | | | | 3 = | |
| | | | | | | TMR | |
| B TM1- | TMR | TMR | TMR | TMR | TMR | TMR | TM1-2- |
| 2-3 | | | | | | | 3 = |
| | | | | | | | TMR |

Tables 1 and 2 define examples of basic cases on which the trust model routing decision is based, covering organizations that use one, two or three trust models TM1, TM2 and/or TM3. According to the invention, the trust model router TMR determines which trust model or multiple trust models are applicable and defines the transaction follow up based on pre-defined rules. An organization that does not conduct transactions using any trust model could, through the trust model router TMR, perform the transaction and use the other parties' trust model or trust models. The trust model router TMR will perform the required transaction process on a behalf of the party that does not use the trust model. This is possible since the trust model router TMR is certified and trusted by trust model TM1, TM2 . . . TMn certification authorities. The trust model router is trusted because it has been issued certificates and it has been certified and trusted by the various trust model certification authorities involved in the transaction.

The trust model router of the invention comprises the following components:

Routing Rules Engine

Trust Models Workflow Database

Extensions Certificates

Validation Server

Transaction Log Database

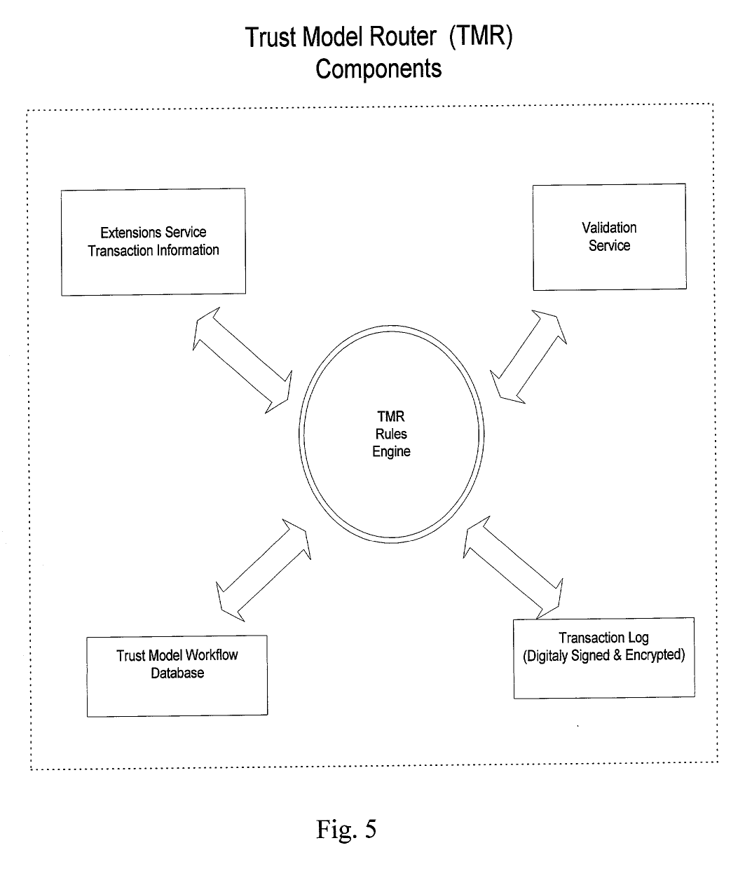

These components, illustrated in FIG. 5, enable the trust model router to route the information according to the specified rules database.

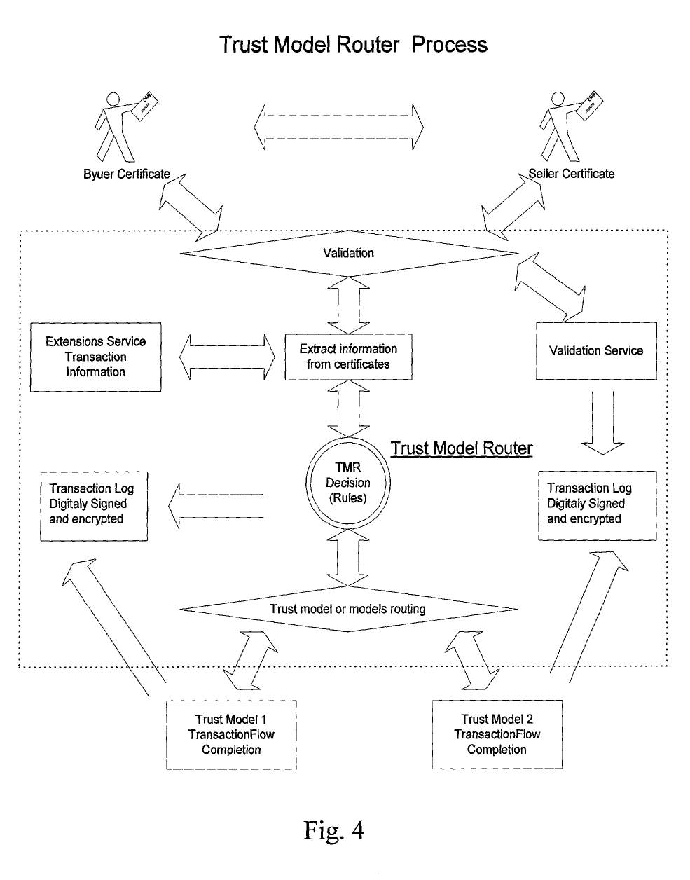

The trust model router process, illustrated in FIG. 4, is based on the trust model and trust model selection criteria. The trust model router selects an appropriate trust model, applications and transactions dedicated to specific trust model member. The trust model router, as a trusted entity, routes between the trust models, bridges the trust models by completing transactions in one trust model environment on behalf of another trust model, and encompassing transactions within one trust model.

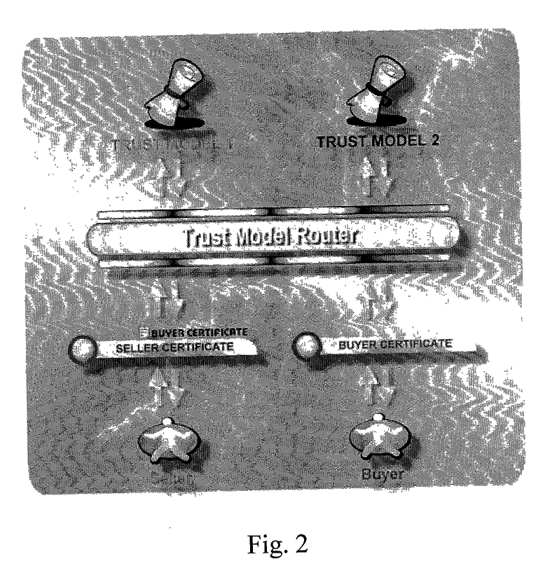

For example, FIG. 2 illustrates the high level presentation of the trust model router process, showing the trust model router TMR ability to decide on a trust model, using the buyer (Client 1) or seller (Client 2) certificate information.

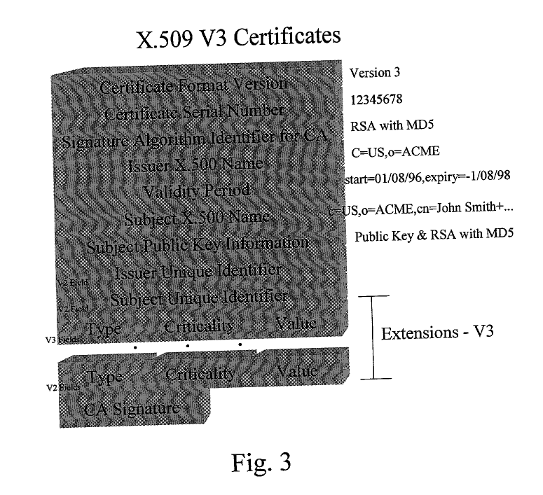

FIG. 3 illustrates a certificate issued to clients by a certificate authority enforcing its specific trust model. The trust model router will use issuer X500 name, subject X500 name, unique identifiers and proper application extensions to perform the requested transaction using proper trust model routing required for that transaction. The transaction is intercepted by the a dispatching software tool in the trust model router. The certificate is validated by the Validation Server, and all relevant information is extracted from the certificate, reorganized into a form compatible with the receiving trust model(s) and embedded in an extension certificate. The transaction is logged and continued in the format of the receiving other trust model(s).

The trust model routing method thus comprises the following steps:

a. Obtaining information about the issuing certificate authority from either a seller (Client 2) or buyer (Client 1) certificate (see FIG. 3) issued by the seller's (Client 2) or buyer's (Client 1) trusted certificate authority;

b. Validating the certificate using a validation server and suitable validation protocols, according to the rules of the trust model as set out in the Trust Models Workflow Database;

c. Determining from the extension certificate server the application that will use the certificate to complete the routed transaction;

d. Determining the originating trust model of the request for a transaction;

e. Selecting suitable trust model routing based on the issuing certificate authority and transaction application, and a lookup of the location/requesting party from the Routing Rules Engine;

f. Stripping extension information from the certificate and reorganizing the extension information into a form compatible with the receiving trust model(s);

g. embedding the extension information in an extension certificate;

h. Routing the Internet based transaction according to the selected one or multiple trust (hybrid) model workflow description in the Trust Models Workflow Database;

i. Logging the transaction information including validation, extension information and rules used in the Transaction Log Database. The transaction log is certified and encrypted using certificates issued by the selected trust model transaction process; and

j. Completing the transaction with transaction verification by the receiving trust model(s).

FIG. 4 illustrates how the selection of a suitable trust model is made and how the transaction is logged.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A system for conducting an Internet based transaction through a plurality of trust models each defining a series of rules for the conduct of an Internet based transaction, comprising
a workflow database comprising workflow parameters associated with the plurality of trust models,
a validation server for validating a certificate issued in accordance with a certificate authority and trust model,
a rules engine for generating an extensions certificate or using an existing extensions certificate comprising selected information extracted from the certificate, and
a transaction log database for recording information relating to the transaction.

2. The system of claim 1 wherein a transaction log is certified and encrypted using certificates issued by a selected trust model transaction process.

3. The system of claim 2 wherein the transaction log comprises information relating to validation, extensions, rules and models used in the transaction.

4. A method of conducting an Internet based transaction, comprising the steps of:
a. Obtaining information about an issuing certificate authority from a certificate issued to a first party according to a first trust model;
b. Validating the certificate according to rules of the first trust model;
c. Selecting from the certificate a transaction application that will use the certificate to complete the transaction;
d. Determining the originating trust model of the request for a transaction;
e. Selecting a trust model routing based on the issuing certificate authority and transaction application and a lookup of the trust model and requesting party from a routing rules engine;
f. Stripping extension information from the certificate and reorganizing the extension information into a form compatible with at least one receiving trust model of at least one other party to the transaction;
g. embedding the extension information in an extension certificate;
h. Routing the requested transaction according to the selected trust model workflow description;
i. Logging transaction information; and
j. Completing the transaction with verification by the at least one receiving trust model.

5. The method of claim 4 in which steps f., h. and j. are applied to a plurality of receiving trust models.

6. The method of claim 4 in which the transaction information is recorded in a transaction log.

7. The method of claim 6 in which the transaction log is certified and encrypted using certificates issued by the selected trust model transaction process.

8. The system of claim 7 wherein the transaction log comprises information relating to validation, extensions, rules and models used in the transaction.
